(19) United States
(12) Patent Application Publication
(10) Pub. No.: US 2023/0217387 A1
(43) Pub. Date: Jul. 6, 2023

(54) ACCURATE REFERENCE TIMING DELIVERY OVER HANDOVER PROCEDURE

(71) Applicant: JRD COMMUNICATION (SHENZHEN) LTD., Shenzhen, Guangdong (CN)

(72) Inventors: Hejun Wang, Shenzhen, Guangdong (CN); Jia SHENG, Shenzhen, Guangdong (CN)

(73) Assignee: JRD COMMUNICATION (SHENZHEN) LTD., Shenzhen, Guangdong (CN)

(21) Appl. No.: 17/996,206

(22) PCT Filed: Apr. 15, 2020
(86) PCT No.: PCT/CN2020/084875

§ 371 Date: Oct. 13, 2022

(51) Int. Cl. H04W 56/00; H04W 36/08; H04W 36/00

(52) U.S. Cl. CPC H04W 56/0015; H04W 36/08; H04W 36/0061

(57) ABSTRACT

Some approaches are provided for a user equipment (UE) to acquire the accurate reference timing of a target cell during the handover procedure. The scheme ensures that UE meets the synchronization accuracy requirement during the process of handover and the continuity of time sensitive services is guaranteed.

### TECHNICAL FIELD

The present disclosure relates to the field of communication systems, and more particularly, to accurate reference Timing delivery over handover procedure.

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) which provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

Time Sensitive Network (TSN) is a set of standards (IEEE 802.1Q TSN Standard) developed by IEEE to define a mechanism for the time-sensitive transmission of data and accurate timing reference over a wired Ethernet network (IEEE 802.3 Ethernet Standard). The accurate reference timing emanates from a central clock source known as Grand Master, and its distribution through a series of hops between nodes is based on the Precision Time Protocol (PTP, IEEE 1588 Precision Time Protocol).

As has been identified in SA1 TR 22.804 and TR 22.821 and documented as key issue in TR 23.734 (key issue #3), one of the important requirements of NR system is support for some form of interworking with Time Sensitive Networking (TSN).

It is agreed in RAN2 #103bis that NR system acts as a “Black Box” in the TSN networking as shown in FIG. 2. In this approach TSN provides the accurate reference timing to the NR system, as shown in FIG. 1. NR system is essentially what IEEE refers to as a “Boundary Clock” (BC), acting as a master clock to all the attached nodes (denoted by dotted box), and the NR system is able to distribute the TSN derived accurate timing to all the UEs in the system. In addition, the NR system is capable of compensating for any time drifts resulting from delays in the air interface and is a topic discussed during the NR IIoT (Industrial Internet of Things) study. The NR system timing maintained by the UE is distributed as PTP packets to all the devices connected to its Ethernet port.

### Technical Problem

For latency sensitive service (e.g., NR IIoT service, XR), if the system is lack of mechanism for accurate reference timing delivery, it would be difficult to meet synchronization accuracy requirement of latency sensitive services. Especially for a moving UE, time synchronization accuracy would be a key problem affecting the UE performing time sensitive services. Therefore, accurate reference timing delivery during handover procedure would be an issue to be solved.

### Technical Solution

A first aspect of the present disclosure provides a method of time synchronization during a handover procedure of a user equipment (UE) between a source base station and a target base station in a cellular wireless communication system, the method performed by the target base station and comprising: receiving or obtaining Time Sensitive Communication (TSC) related information including accurate reference timing request during the handover procedure; and in response to the accurate reference timing request, delivering accurate reference timing to the UE during the handover procedure.

A second aspect of the present disclosure provides a method of time synchronization during a handover procedure of a user equipment (UE) between a source base station and a target base station in a cellular wireless communication system, the method performed by the source base station and comprising: receiving or obtaining accurate reference timing related information; sending the accurate reference timing related information to the target base station during the handover procedure; receiving the accurate reference timing related information from the target base station; and forwarding the received accurate reference timing related information to the UE during the handover procedure.

A third aspect of the present disclosure provides a method of time synchronization during a handover procedure of a user equipment (UE) between a source base station and a target base station in a cellular wireless communication system, the method performed by the UE and comprising: receiving accurate reference timing transmitted from the target base station during the handover procedure; and synchronizing to the target base station with the accurate reference timing.

A fourth aspect of the present disclosure provides a method of handover decision, the method performed by a serving cell serving a user equipment (UE), the method comprising: obtaining neighboring cell information about whether neighboring cells meet accurate reference timing requirement; transmitting time sensitive services related measurement configuration including the neighboring cells meeting the accurate reference timing requirement; receiving a time sensitive services related measurement report that is reported based on the time sensitive services related measurement configuration; and selecting a candidate cell to handover to based on the time sensitive services related measurement report.

A fifth aspect of the present disclosure provides a method of measurement and reporting, the method performed by a user equipment (UE) and comprising: receiving or obtaining time sensitive services related measurement configuration including the neighboring cells meeting accurate reference timing requirement; performing time sensitive services related measurement for the neighboring cells meeting the accurate reference timing requirement to generate a time sensitive services related measurement report; and transmitting the time sensitive services related measurement report.

The disclosed method may be implemented in user equipment, a source base station, or a target base station.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as computer program product, that causes a computer to execute the disclosed method.

The disclosed method may be programmed as computer program, that causes a computer to execute the disclosed method.

### Advantageous Effects

The disclosed scheme ensures that the moving UEs supporting time sensitive services meet the synchronization accuracy requirement during the process of handover and the continuity of time sensitive traffic is guaranteed.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating TSN high level architecture with 5G.

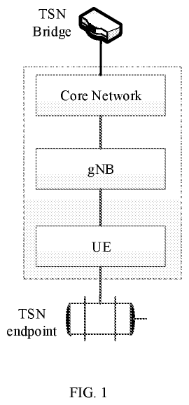

FIG. 2 is a schematic diagram illustrating a NR system acting as a Black Box in TSN Networking.

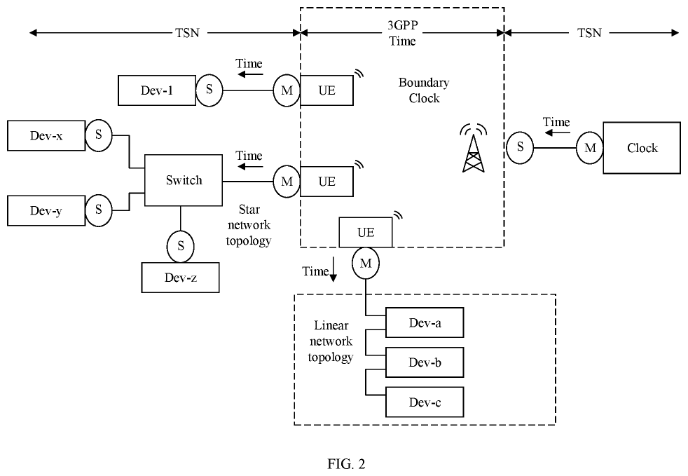

FIG. 3 is a flowchart of a method of time synchronization during a handover procedure according to a first embodiment of the present disclosure.

FIG. 4 is a flowchart of a method of time synchronization during a handover procedure according to a second embodiment of the present disclosure.

FIG. 5 is a flowchart of a method of time synchronization during a handover procedure according to a third embodiment of the present disclosure.

FIG. 6 is a flowchart of a method of cell (re)selection according to a fourth embodiment of the present disclosure.

FIG. 7 is a block diagram of a system for wireless communication according to an embodiment of the present disclosure.

FIG. 8 is a schematic diagram illustrating a handover procedure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

For mobility is one of the important issues, mechanism is needed to make sure that time synchronization accuracy should meet the requirement during handover procedure. Namely, accurate reference timing of a target cell should be sent to a user equipment (UE) as soon as possible.

In this disclosure, some approaches are disclosed for the UE to acquire the accurate reference timing of the target cell during the handover procedure. The scheme ensures that UE meets the synchronization accuracy requirement during the process of handover and the continuity of time sensitive traffic (e.g., Time Sensitive Network (TSN) traffic) is guaranteed.

In the handover procedure, UE handover is performed between a source base station (e.g., a source gNB) and a target base station (e.g., a target gNB) in a cellular wireless communication system. The main idea of this disclosure is that the target base station can obtain Time Sensitive Communication (TSC) related information from a source base station or from a core network (CN) or Network (NW), such as a 5G-core network (5GC), during the handover procedure. Then, the target base station provides accurate reference timing to the UE during handover procedure. Therefore, the UE can synchronize to the target base station with the synchronization accuracy meeting the requirement of time sensitive traffic as soon as possible so that time sensitive traffic will not be interrupted due to loss of synchronization or synchronization accuracy.

In another aspect, a serving cell (e.g., a serving gNB) that serves a UE may obtain neighboring cell information to know whether neighboring cells support time sensitive services or meet accurate reference timing requirement, and configures the UE to perform measurement on the neighboring cells that support the time sensitive services. The UE generates a measurement report and sends it to the serving cell. Then, the serving cell makes handover decision based on the measurement report and/or the neighboring cell information, that is, the serving cell decides whether to handover the UE to the neighboring cell and/or which cell to handover to. In addition, a base station may broadcast accurate reference timing related system information (SI) through broadcasting a system information block (e.g., SIB9). The UE in RRC_IDLE state and RRC_INACTIVE state receives the SI during random access procedure and performs cell (re)selection based on the acquired SI.

### Embodiment 1

This embodiment mainly focuses on providing TSC related information including accurate reference timing request to the target base station during handover preparation phase. If the target base station supports time sensitive services (e.g., TSN related services) and its corresponding accurate reference timing meets the requirement, then the target base station transmits or deliveries accurate reference timing to UE during handover preparation phase.

The TSC related information the target base station obtained might include an accurate reference timing request message and might also include TSC Assistance Information (TSCAI). The TSCAI itself describes TSC traffic characteristics. For example, the knowledge of TSN traffic pattern is useful on figuring out the periodicity and latency requirement so that the UE can determine the time synchronization accuracy and uncertainty of the reference timing.

The TSCAI contains at least service-type related information or reference-timing related information. The service-type related information can be in any form, e.g., an indicator such as S-NSSAI. The reference-timing related information consists of at least one of the information elements (IEs) contained in SIB9 and DLInformationTransfer, e.g., clock type, uncertainty, etc., or any information else such as speed, periodicity. The content and form of the accurate reference timing request message are not limited or are not standardized yet. Any other information might be included in the TSCAI, such as UE's location information, distance between UE and base station, location information, etc.

The source base station can obtain accurate reference timing related information from at least one of UE and a core network (e.g., 5GC), or be preconfigured. In an embodiment, during handover preparation phase, the source base station sends the accurate reference timing related information including accurate reference timing request to the target base station and then receives the accurate reference timing related information including accurate reference timing response from the target base station through an Xn interface. Then, the source base station forwards the accurate reference timing related information to the UE. The accurate reference timing related information sent from the source base station to the target base station might also include TSCAI. In another embodiment, during handover preparation phase, the source base station sends accurate reference timing request to the target base station, then the target base station gets related TSCAI from the core network that is needed to make decision on whether it meets the requirement of the accurate reference timing the UE supports and whether to or how to and in which way to perform accurate reference timing delivery to the UE. The determination on whether the target base station meets the requirement may be based on the accurate reference timing request message and all or part of TSCAI that are obtained from the source base station; alternatively, the determination on whether the target base station meets the requirement may be based on the accurate reference timing request message obtained from the source base station and TSCAI obtained from the core network.

After receiving the accurate reference timing related information mentioned above, the target base station would perform the accurate reference timing delivery to the UE. The way and form that the target base station provides the accurate reference timing related information to the UE may be varied. For instance, the target base station may transmit the accurate reference timing related information to the source base station through the Xn interface or via the core network (e.g., 5GC), then the source base station sends or forwards a message to the UE in a way that can be broadcast SIB, Radio Resource Control (RRC) signaling unicast, carried or piggybacked in user data, MAC Control Element (MAC CE) or any way else. In another way, the target can broadcast accurate reference timing related SI periodically, transmit or deliver the accurate reference timing related message or information through downlink transmission during handover procedure, e.g., a Random Access Response (RAR) message, or through context forwarded to UE during context exchange phase of the handover procedure, etc.

The UE receives the target base station's accurate reference timing related message or information and performs handover.

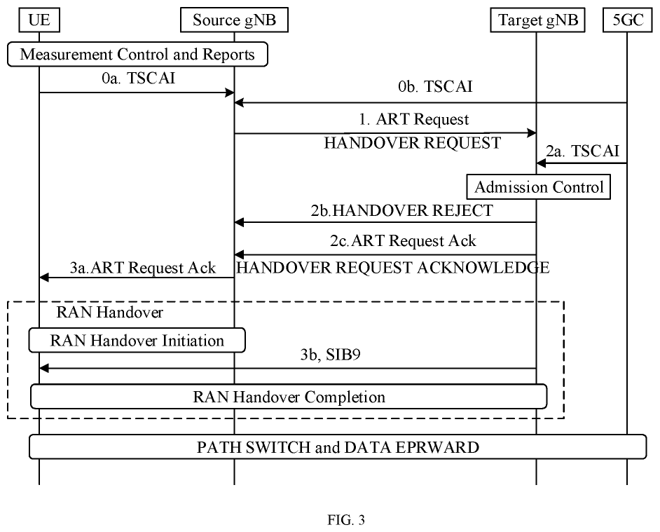

FIG. 3 is a flowchart of a method of time synchronization during a handover procedure according to a first embodiment of the present disclosure. UE handover is performed between a source base station (e.g., a source gNB) and a target base station (e.g., a target gNB). It is assumed that 1) both UE and source base station support TSN traffic; 2) UE is in RRC_CONNECTED state with source base station; 3) UE is performing measurement and measurement report; and 4) handover condition was met.

Referring to FIG. 3, the source base station obtains TSCAI related to the time sensitive traffic (e.g., TSN traffic) the UE supports. Where and how the source base station gets the TSCAI may be varied. The composition of the TSCAI may be currently standardized or meet further standards. In an embodiment, the source base station receives the TSCAI from the UE, like step 0a. In another embodiment, the source base station obtains the TSCAI from the core network (e.g, 5GC), like step 0b. In yet another embodiment, the TSCAI can be preconfigured or standardized. The TSCAI can be obtained by the source base station through at least one of the described embodiments. The TSCAI can be any information related to the accurate reference timing delivery.

In step 1, the source base station transmits an accurate reference timing (ART) request message to a selected target base station.

The accurate reference timing request message might contain accurate reference timing request and might also include part of the TSCAI. The specific content and form of the accurate reference timing request message is not specified or limited. It is used for the target base station to know the accurate reference timing requirement of the UE's time sensitive service.

The accurate reference timing request message sent to the target base station by the source base station might be obtained from the UE or generated by the source base station. In an embodiment, the UE sends a measurement report to the source base station, then the source base station generates the accurate reference timing request message and transmits it to the target base station. In another embodiment, the UE sends the accurate reference timing request message to the source base station, and the source base station forwards the accurate reference timing request message to the target base station.

In an embodiment, the source base station might transmit the accurate reference timing request message carried or piggybacked in a handover command, e.g., HANDOVER REQUEST message. In another embodiment, one bit or a field of several bits in the handover command might be used to indicate that the target base station should support accurate reference timing or perform the accurate reference timing delivery. Any combination of the described embodiments is allowed in the disclosure.

In step 2, the target base station receives the accurate reference timing request from the accurate reference timing request message from the source base station, performs admission control and sends a response message to the source base station.

Some information might be needed for the target base station to decide whether it meet the accurate reference timing requirement of the time sensitive traffic (e.g., TSN traffic) that the UE supports. In an embodiment, the information can be obtained from the core network (e.g., 5GC), like step 2a depicted. In another embodiment, the information can be extracted from the accurate reference timing request message sent from the source base station.

If the target base station don't meet the requirement of the UE's time sensitive service, handover request is denied, and a handover reject message such as HANDOVER REQUEST REJECT is sent from the target base station to the source base station as step 2b depicted.

In an embodiment, if the target base station accepts the handover request, a handover request acknowledge message such as HANDOVER REQUEST ACKNOWLEDGE message is sent from the target base station to the source base station like step 2c depicted, and an accurate reference timing response message can be carried or piggybacked in the handover request acknowledge message in any form. In another embodiment, if the target base station accepts the handover request, a handover request acknowledge message such as HANDOVER REQUEST ACKNOWLEDGE message is sent from the target base station to the source base station and the target base station broadcasts accurate reference timing related system information (SI) (e.g., SIB9), periodically like step 3b. The periodicity and times can be concluded from at least one of the accurate reference timing request message and TSCAI. The action of the target base station can be any combination of the described embodiments.

In step 3, the UE captures accurate reference timing and perform handover.

In an embodiment, the UE obtains the accurate reference timing by receiving the accurate reference timing response message from the source base station. In another embodiment, the UE receives the accurate reference timing related SI broadcasting from the target base station.

### Embodiment 2

This embodiment discloses the method that the accurate reference timing can be requested during handover initiated random access procedure.

Accurate reference timing request can be indicated to the target base station through the dedicated random access preamble or random access time-frequency resource with which the UE launches the handover initiated random access procedure. Or the accurate reference timing request can be transmitted to the target base station and carried or piggybacked by Random Access Preamble Packet or Message 3. Then, the target base station may perform accurate reference timing delivery with accurate reference timing related message included in RAR or Message 4. The SIB broadcasting can be another way to transmitting the accurate reference timing.

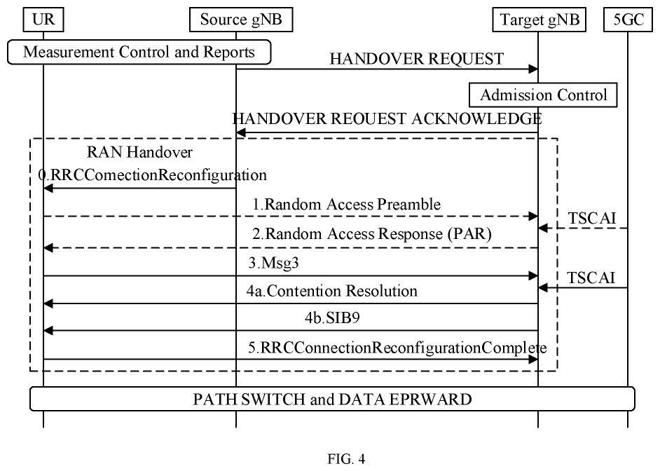

FIG. 4 is a flowchart of a method of time synchronization during a handover procedure according to a second embodiment of the present disclosure. UE handover is performed between a source base station (e.g., a source gNB) and a target base station (e.g., a target gNB). It is assumed that 1) both UE and the source base station support time sensitive services; 2) UE is in RRC_CONNECTION state with source base station; 3) UE is performing measurement and measurement report; 4) handover procedure is triggered; and 5) handover initiated random access can be contention free random access and contention based random access.

For Contention Free Random Access Scenario:

Referring to FIG. 4, in step 0, the source base station transmits RRCConnectionReconfiguration message to the UE indicating the UE to perform contention free random access. Dedicated time-frequency resources can be allocated for the UE to perform random access procedure, and the configuration or specification can be available for contention free random access, contention based random access, or both. The configuration above can be RACH-ConfigIndex, prach Mask Index, ra-PreambleIndex in RACH-ConfigDedicated, Preamble Index in DCI format 1A, etc.

For contention free random access, one or several preambles can be used to indicate to the target base station that the UE sends the dedicated random access preamble supporting the time sensitive services and requires accurate reference timing delivery. The rules above can be standardized, configurable or up to implementation, etc. The configuration about which time-frequency resources and/or preambles is used for the UE to perform random access can be transmitted to the UE via carried or included in RRCConnectionReconfiguration message.

The details about how the source base station indicates the UE and the content of the indication are not specified or limited in the disclosure. It can be any combination of above methods and anything else.

In step 1, the UE sends Random Access Preamble to the target base station with the dedicated preamble and/or time-frequency resource as was configured/standardized. The preamble index and prach Mask Index show that this random access is initiated by the UE supporting the time sensitive services. The target base station identifies that the random access preamble sent by the UE requires accurate reference timing delivery service, then the target base station decides whether to accept the access and how to response.

In step 2, the target base station receives the random access preamble, then performs accurate reference timing delivery and send RAR back to the UE. The target base station receives the random access preamble sent with dedicated resource or/and preamble index, and identifies that accurate reference timing delivery should be performed. The target base station acquires some other accurate reference timing related information that is needed to perform the accurate reference timing delivery, e.g., TSCAI from the core network (e.g., 5GC) or the source base station.

In an embodiment, the accurate reference timing can be delivered with or piggybacked in RAR message. In another embodiment, the target base station may perform the accurate reference timing delivery via SI broadcasting. The UE can obtain accurate reference timing from receiving RAR or SI from target base station.

If the target base station do not support accurate reference timing delivery services, the access might be denied.

For Contention Based Random Access Scenario:

Referring to FIG. 4, in step 0, the source base station transmits RRCConnectionReconfiguration message to the UE indicating the UE to perform contention based random access. The RRCConnectionReconfiguration message might be a regular operation as currently standardized; or the RRCConnectionReconfiguration message can indicate the UE to transmit random access preamble with time-frequency resource dedicated for time sensitive services, etc. The dedicated time-frequency resources mentioned before can be allocated for UEs supporting time sensitive services to perform random access preamble transmission. The allocation can be configurable and/or currently standardized, etc.

In step 1, the UE sends random access preamble to the target base station. The UE may select and send the random access preamble to the target base station as specified in the handover initiated random access procedure in NR standard; or the UE may send random access preamble with dedicated time-frequency resources for time sensitive services. The dedicated time-frequency resources may be configured or standardized for time sensitive services.

The behavior might be that, the UE receives configuration indicating the UE to perform contention based random access, and the UE chooses the dedicated time-frequency resource sending the random access preamble; or the UE receives configuration indicating the UE to perform time sensitive services specific contention based random access, and the UE chooses the dedicated time-frequency resource sending the random access preamble; or The dedicated time-frequency resource is indicated in the RRCConnectionReconfiguration message, and the UE use the indicated time-frequency resource sending the random access preamble.

In step 2, the target base station sends RAR back to the UE. The target base station may send RAR message to the UE as is regularly specified in the 3GPP standard. Alternatively, the target base station receives the random access preamble sent with the dedicated time-frequency resource, and behaviors as described in contention based random access procedure, acquires accurate reference timing related information, generates accurate reference timing message and sends it to the UE carried in the RAR message.

Accurate reference timing related information might be transmitted to UE by the target base station through broadcasting accurate reference timing related SI, e.g., SIB9. The target base station may obtain accurate reference timing related information from the core network (e.g, 5GC), or source base station, or specified in the 3GPP standard. Then the target base station broadcasts the accurate reference timing related SI. UE receives the SI and obtains the accurate reference timing information of the target base station.

The target base station may postpone to send accurate reference timing related message in message 4 (step 4b).

In step 3, the UE sends message 3 to the target base station and the accurate reference timing. Accurate reference timing request and/or TSCAI may be sent from the UE to the target base station. The accurate reference timing request and/or TSCAI may be encapsulated, carried or piggybacked in message 3.

In step 4, the target base station sends message 4 to the UE. Accurate reference timing delivery related message may be transmitted to the UE in message 4. The generation of accurate reference timing delivery related message can reuse the methods described in above steps, including contention free random access and Embodiment 1.

Go on with the rest steps of the handover procedure. The UE sends RRCConnectionReconfigurationComplete message to the target base station (step 5), performs path switch and context exchange, etc.

### Embodiment 3

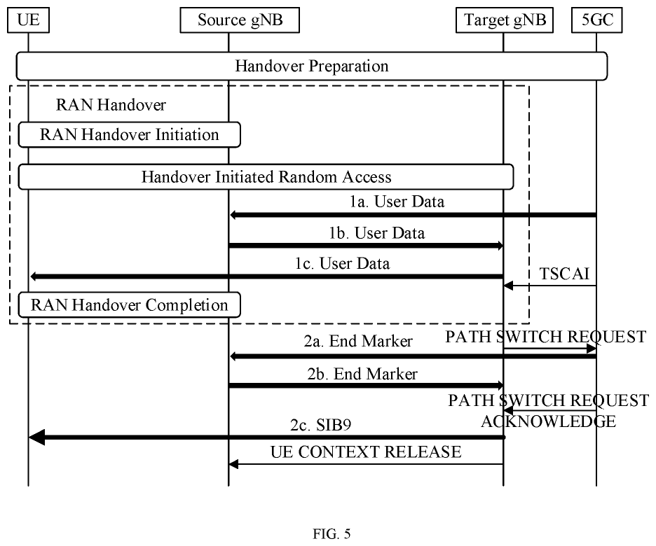

FIG. 5 is a flowchart of a method of time synchronization during a handover procedure according to a third embodiment of the present disclosure. UE handover is performed between a source base station (e.g., a source gNB) and a target base station (e.g., a target gNB). The accurate reference timing request and response can be transmitted through user plane data exchange operation during handover procedure as shown in FIG. 5. When the UE successfully performed random access and enters RRC_CONNECTED state with the target base station but does not complete Path Switch operation, the source base station would forward the data from the core network (e.g., 5GC) to the target base station, then the data can be transmitted to the UE as steps 1a to 1c shown in FIG. 5. Similarly, End Marker from the core network can be transmitted to the target base station via the source base station after path switch operation.

Accurate reference timing request and related information can be transmitted to the target base station from the source base station encapsulated in user data (step 1b) and/or End Marker message (step 2b). The target base station may send the accurate reference timing to the UE with the user data forwarded to UE (step 1c) and/or through SI broadcasting (step 2c).

In the following, it is assumed that 1) both UE and source base station support time sensitive services; 2) UE is in RRC_CONNECTED state with the source base station; 3) UE is performing measurement and measurement report; 4) handover procedure is triggered; 5) UE successfully accessed to the target base station and enters RRC_CONNECTED state.

After the handover initiated random access procedure is successfully completed and the UE enters RRC_CONNECTED state with the target base station. The source base station would forward the user data received from the core network (e.g., 5GC) that should be sent to the UE to the target base station. Accurate reference timing request and related information can be sent to the target base station carried in the user data above as is shown in step 1b. The same operation can be performed with the End Marker message as is shown in step 2a and 2b. Namely the accurate reference timing request and related message can be included in the End Marker message and transmitted to the target base station too.

The target base station performs accurate reference timing delivery by packing accurate reference timing related information in the user data packet or End Marker message and sends it to the UE as step 1c shown in FIG. 5, or the target base station may broadcast accurate reference timing related SI as step 2c shown in FIG. 5.

### Embodiment 4

A serving base station that serves UE obtains neighboring cell information about whether the neighboring cells meet accurate reference timing requirement, and configures the UE in RRC_CONNECTED state to perform time sensitive service related measurement on the neighboring cells that support accurate reference timing services or time sensitive services. The time sensitive service related measurement report may contains cell IDs that both support time sensitive services and meet the handover conditions. The serving base station determines which cell to handover according to the time sensitive services related measurement report.

Time sensitive service related measurement report can be periodic and event triggered. For event triggered time sensitive services related measurement report, the serving base station may configure the UE with values of thresholds. If one of the events happens, the measured variables (e.g., RSRP/RSRQ/SINR) are reached or exceeds the (pre)configured/standardized threshold(s).

Event(s) on time sensitive services related handover may be defined—if the measurement result is greater than, greater than or equal to threshold a (for Event a) or/and less than, less than or equal to threshold b (for Event b), the corresponding event will be triggered, namely the UE is to perform the time sensitive services related measurement report.

Alternatively, the UE may be configured to perform regular measurement and report to the serving base station as is specified in the 3GPP standard, then the serving base station selects the candidate cell to handover to based on the measurement report and neighboring cell information about whether the neighboring cells support time sensitive services or meet the time synchronization accuracy requirements.

Base station may broadcast accurate reference timing related SI through broadcasting a system information block (e.g., SIB9). The UE in RRC_IDLE state and RRC_INACTIVE state receives the SI during random access procedure and performs cell (re)selection based on the acquired SI.

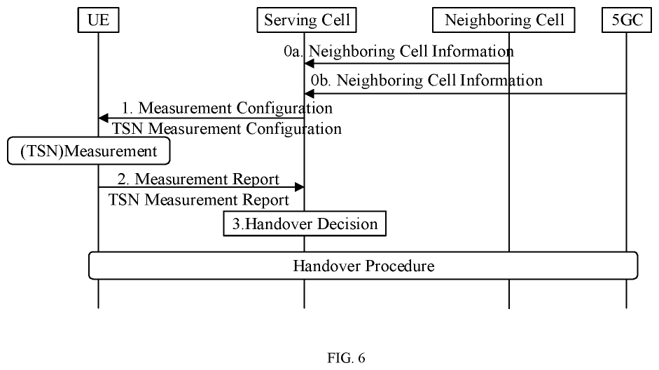

FIG. 6 is a flowchart of a method of cell (re)selection according to a fourth embodiment of the present disclosure. It is assumed that 1) both UE and serving gNB support time sensitive services; 2) UE is in RRC_CONNECTED state with the serving gNB; 3) the serving cell determines whether to perform handover and which cell to handover to.

a) UE receives measurement configuration.

The serving base station acquires neighboring cell information including at least whether the time sensitive service is supported, from the neighboring cells (step 0a) or/and the core network (e.g., 5GC) (step 0b). The measurement and report configuration can be regular configuration messages as is specified in 3GPP standard. In another way, the cell information (e.g., cell IDs supporting time sensitive services) may be included in the measurement and report configuration messages.

b) UE performs measurement and report.

In an embodiment, the UE in RRC_CONNECTED state receives measurement and report configuration from the serving cell (step 1), and performs measurement and report according to the exist mechanism described in the 3GPP standard. In another embodiment, the UE performs measurement on the neighboring cells indicated in the measurement configuration messages that support time sensitive services (step 1).

The UE transmits measurement result to the serving cell periodically and/or triggered by related events (step 2). Events on time sensitive services related measurement report may be defined to trigger the UE to perform measurement report, and related parameters (e.g., threshold) can be configured to UE.

c) The serving base station receives measurement report, then makes handover decision and performs handover procedure.

In an embodiment, the measurement report contains cell information (e.g., cell IDs) that supports time sensitive services, the serving base station determines which cell to handover to based on the measurement report (step 3). In another embodiment, the serving base station makes handover decision based on the measurement report received from the UE and neighboring cell information obtains from the neighboring cells or/and the core network (e.g., 5GC) (step 3).

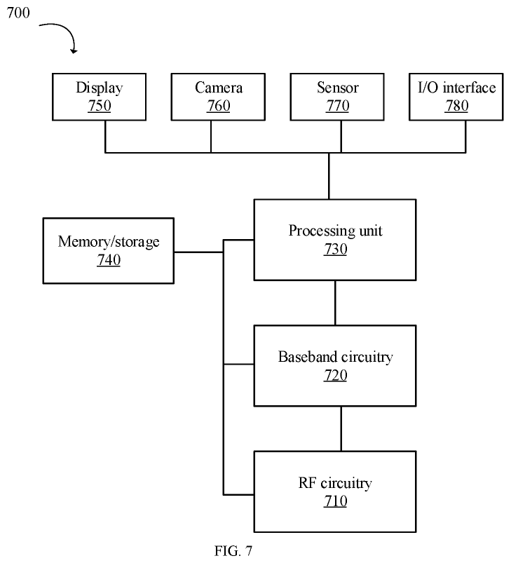

FIG. 7 is a block diagram of an example system 700 for wireless communication according to an embodiment of the present disclosure. Embodiments described herein may be implemented into the system using any suitably configured hardware and/or software. FIG. 7 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

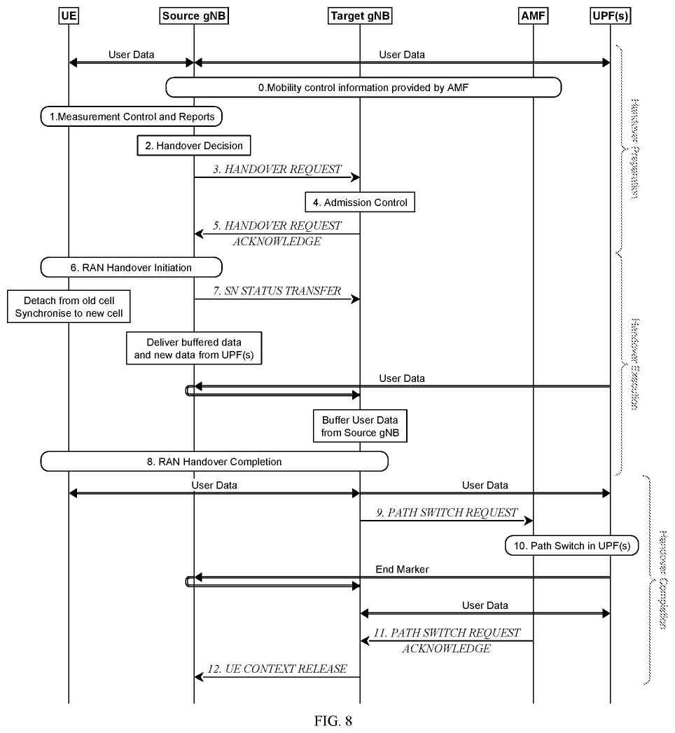

As is shown in FIG. 8, the handover procedure mentioned in the disclosure consists of at least handover preparation phase, handover execution phase and handover completion phase.

In the handover preparation phase, UE performs measurement and reporting according the measurement and reporting configuration received from base station or according to related standard specification. When handover condition is met, the source base station sends handover request to a selected or candidate target base station. If the handover request is accepted by the candidate target base station, the target base station sends handover request acknowledge to the source base station. Then, the RAN handover is initiated.

According to the configuration from the source base station, e.g., RrcConnectionReconfiguration, the UE performs handover initiated random access procedure (e.g., contention free random access or contention free random access) in the handover execution phase. Remaining data from the core network would be forwarded to the target base station by the source base station before path switch is complemented.

Then, path switch would be performed in the handover completion phase. A path switch request is made from the target base station to the core network and, once acknowledged, the data can flow from the UE through the target base station to release UE context.

1-73. (canceled)

74. A method of time synchronization during a handover procedure of a user equipment (UE) between a source base station and a target base station in a cellular wireless communication system, the method performed by the target base station and comprising:
receiving or obtaining Time Sensitive Communication (TSC) related information including accurate reference timing request during the handover procedure; and
in response to the accurate reference timing request, delivering accurate reference timing to the UE during the handover procedure.

75. The method according to claim 74, wherein the TSC related information is obtained during handover preparation phase.

76. The method according to claim 74, wherein the accurate reference timing request is carried or piggybacked in a handover command.

77. The method according to claim 76, further comprising:
in response to the handover command, transmitting a handover request acknowledge message with an accurate reference timing response message carried or piggybacked in the handover request acknowledge message, wherein the accurate reference timing is delivered to the UE via the source base station.

78. The method according to claim 74, wherein the TSC related information is obtained through an End Marker message during path switch operation of the handover procedure.

79. The method according to claim 74, further comprising:
broadcasting accurate reference timing related system information (SI) such that the accurate reference timing is broadcasted to the UE.

80. The method according to claim 74, further comprising:
determining, based on the TSC related information, whether accurate reference timing requirement of a time sensitive service that the UE uses is met.

81. The method according to claim 74, wherein the TSC related information is obtained during handover initiated random access procedure.

82. The method according to claim 74, wherein in the obtaining step, the TSC related information comprises the accurate reference timing request indicated by dedicated random access preamble(s) or dedicated time-frequency resource(s) used for sending random access preamble(s); or the TSC related information comprises the accurate reference timing request carried or piggybacked in random access preamble packet; or the TSC related information comprises the accurate reference timing request carried or piggybacked in Message 3.

83. The method according to claim 74, wherein in the delivering step, the accurate reference timing is delivered to the UE through a Random Access Response (RAR) message; or the accurate reference timing is delivered to the UE through Message 4.

84. The method according to claim 74, wherein the TSC related information is obtained through a user plane data exchange operation after successfully performing handover with the UE and before path switch operation.

85. The method according to claim 84, wherein in the delivering step, the accurate reference timing is delivered to the UE by the target base station with the accurate reference timing packaged in the user data.

86. A method of time synchronization during a handover procedure of a user equipment (UE) between a source base station and a target base station in a cellular wireless communication system, the method performed by the UE and comprising:
receiving accurate reference timing transmitted from the target base station during the handover procedure; and
synchronizing to the target base station with the accurate reference timing.

87. The method according to claim 86, wherein the accurate reference timing is received during handover preparation phase.

88. The method according to claim 86, wherein the accurate reference timing is received during a handover initiated random access procedure.

89. The method according to claim 86, wherein requirement of accurate reference timing delivery is indicated by dedicated random access preamble(s) or time-frequency resource(s) used to send random access preamble(s) to the target base station; or requirement of accurate reference timing delivery is indicated by random access preamble sent to the target base station.

90. The method according to claim 86, wherein in the receiving step, the accurate reference timing is received through a Random Access Response (RAR) message; or the accurate reference timing is received through Message 4; or the accurate reference timing is received by receiving a broadcasted information; or the accurate reference timing is received by Radio Resource Control (RRC) signaling unicast from the source base station to the UE; or the accurate reference timing is received by MAC Control Element (MAC CE).

91. The method according to claim 86, wherein in the receiving step, the accurate reference timing is received by receiving user data transmitted from the target base station after the UE successfully performs handover with the target base station; or the accurate reference timing is received by receiving a system information block broadcasted by the target base station during path switch operation.

92. A base station, comprising:
a processor, configured to call and run program instructions stored in a memory, to execute the method of claim 74.

93. A user equipment, comprising:
a processor, configured to call and run program instructions stored in a memory, to execute the method of claim 86.
